(19) United States
(12) Patent Application Publication
(10) Pub. No.: US 2020/0057920 A1
(43) Pub. Date: Feb. 20, 2020

(54) System and Method of Quotation Engine for AI Asset Training

(71) Applicant: CrowdCare Corporation, Richmond Hill (CA)

(72) Inventors: Ian Collins, Markham (CA); Jeffrey Brunet, Aurora (CA); Karthik Balakrishnan, Etobicoke (CA); Yousuf Chowdhary, King City (CA); Karen Chan, Richmond Hill (CA)

(21) Appl. No.: 16/544,313

(22) Filed: Aug. 19, 2019

Related U.S. Application Data
(60) Provisional application No. 62/720,062, filed on Aug. 20, 2018.

(51) Int. Cl. G06K 9/62; G06N 20/00; G06Q 20/06

(52) U.S. Cl. CPC G06K 9/6262; G06K 9/6269; G06Q 20/0655; G06K 9/6256; G06N 20/00; G06K 9/627

(57) ABSTRACT

A computer-implemented system is provided for automatic training of an artificial intelligence (AI) asset. A preprocessing engine is provided for receiving an AI asset by upload and preprocessing the AI asset for training by: associating a set of definition parameters and training criteria with the AI asset; analyzing the training criteria to set a specification for training steps and process; and determining a quotation for the training having regard to known factors associated with the definition parameters and the training specification. A transaction engine is provided for presenting the quotation, receiving an approval of the quotation and a means of payment. A training engine is provided for training the AI asset according to the specification and releasing the AI asset after training.

### CROSS REFERENCE TO RELATED APPLICATIONS

This application claims the benefit of U.S. Provisional Patent Application No. 62/720,062, filed Aug. 20, 2018, the contents of which is hereby incorporated by reference in its entirety.

### FIELD OF INVENTION

The invention in general relates to artificial intelligence (AI) and in particular relates to providing a system and method for automatically creating a quotation for AI asset training.

### BACKGROUND OF THE INVENTION

Artificial Intelligence (AI) aims to be able to provide capabilities such that computing platforms can perform intelligent human processes such as reasoning, learning, problem solving, perception, language understanding etc. AI also aims to use computing to solve problems related to prediction, classification, regression, clustering, and function optimization amongst a host of others.

It would be advantageous to have a mechanism to receive, analyze and automatically quote on training of AI assets to facilitate development of AI assets through available resources.

Existing methods do not provide mechanisms or platforms that enable the exchange of different artificial intelligence (AI) assets developed by different entities; whether for monetary gain or for open source resource development or for collaborative work.

Prior art methods also do not provide mechanisms for automated training of AI assets by third parties and providing a quotation to third parties requesting training for their AI assets, which would greatly facilitate trade of AI assets, so that entities could benefit from the AI resources developed by others to speed up the evolution of their own AI assets.

### SUMMARY

Broadly speaking, the present invention provides a method and a system of Quotation Engine that can automatically generate a quotation in response to a user requesting an AI asset to be trained. The quotation engine is desirably a part of a larger AI Asset Exchange. One related AI Asset Exchange method and system is described and taught in applicants' previous U.S. patent application Ser. No. 16/404,849, filed on May 7, 2019, the contents of which are incorporated herein by reference.

Such an AI Asset Exchange would preferably permit different entities to buy, sell, barter, trade, rent, borrow, exchange, collaborate, retrain their AI assets etc. The AI Asset Exchange may be responsible for grading AI assets, management, transaction management, rights and encryption key(s) management, data management, model management, automated training, providing automated quotes in response to requests for AI asset training amongst other related functions. One such evaluation and grading tool is described and taught in applicants' previous US patent application Ser. No. 16/507,230, filed on Jul. 10, 2019, the contents of which are incorporated herein by reference.

It would be advantageous to have a mechanism for such an Exchange to automatically generate a quotation in response to a user requesting an AI asset to be trained using multiple different Al assets potentially belonging to many different entities, which would ultimately facilitate trade and transaction of different AI assets by having them trained or retrained and thus increasing their value.

An AI asset can be data or a model; and any AI asset can be bought, sold, rented, leased; fully (whole) or partially (a subset of the data, say 50%) bartered, exchanged, borrowed, collaborated on etc. An AI asset is tangible (e.g. data or model) and can be transacted, can be assigned value, can be graded by the system and rated by the user, can be extended or muted. The AI Asset Exchange can be responsible for asset management, transaction management, rights (encryption key) management, data management, model management, grading of assets.

The application cites several examples for AI assets, and the intent is to cover all such AI software, modules, models, algorithms etc. that may exist currently or will be developed or may evolve over time as a result of the advancements in the relevant fields of computing.

In one embodiment Entity A logs into an AI Asset Exchange. This Exchange may offer a platform that acts like a stock exchange where AI assets can be transacted by different parties. The AI Asset Exchange may be responsible for automatically providing a quote in response to a user seeking to have their AI assets trained, grading AI assets, management, transaction management, rights and encryption key(s) management, data management, model management, amongst other related functions.

In one embodiment Entity A can opt to have an AI asset automatically trained to facilitate in accelerating the evolution of its AI asset by leveraging the AI resources developed by other entities and available for trade via an AI Asset Exchange.

In one embodiment Entity A defines the AI asset and provides training criteria which may include but is not limited to accuracy, precision, etc. In certain embodiments the system itself analyzes the AI asset to be trained, preferably using other systems and sub-systems that are either integral to the AI Asset Exchange or in collaboration with other systems that may be external to it and accessible for such purposes.

The training requirements may be defined by Entity A who may own or may have rights to the AI assets for which training is being sought. This may include training steps/process that may be required to achieve the desired level of requirements that were earlier set by Entity A as requirements for the training. These may also be automatically determined by the system based on analysis (e.g. to achieve a level of training desired by Entity A).

The system may, e.g., determine the CPU and hardware requirements that may be utilized during the training process. In some embodiments these may be broad projections and estimates utilizing past historical data to arrive at the specifics. In some embodiments an element of time may also be used to determine the overall length of the training process and the resources that may be required over this length of time. In some embodiments it may also require that a request to book the resources is also automatically generated and a projected schedule is created that may determine when the training is to commence and when it can be expected to be complete.

The system may, e.g., analyse and calculate the time that may be required, the energy that may be consumed or other resource requirements for the training, such as the number of CPUs and their usage load and yields of task completion. These may also be used as a criteria for generating an automated quotation in response to an entity seeking training for its AI asset.

The system preferably gathers the cost/ascribed value price etc. for each of these steps and the the costs of any other AI assets that may be required for this process in order to compile a quotation in response to the request and requirements set by Entity A for the training of an AI asset.

The quotation generation itself may be reliant on artificial intelligence machine learning algorithms that can learn and adapt as the system processes different AI asset training requests from different users.

According to a first aspect of the invention, a computer-implemented system is provided for automatic training of an artificial intelligence (AI) asset. A preprocessing engine is provided for receiving an AI asset by upload and preprocessing the AI asset for training by: associating a set of definition parameters and training criteria with the AI asset; analyzing the training criteria to set a specification for training steps and process; and determining a quotation for the training having regard to known factors associated with the definition parameters and the training specification. A transaction engine is provided for presenting the quotation, receiving an approval of the quotation and a means of payment. A training engine is provided for training the AI asset according to the specification and releasing the AI asset after training.

The factors may include at least one of: industry, use case, scope and use of the AI asset, desired level of accuracy, and desired level of performance.

The factors may include at least one of: type of third party AI assets needed for training, type and scope of data needed for training, and access cost and availability of training data sets.

The factors may include at least one of: estimated number of training iterations, and CPU, hardware and time to do training.

The definition and training criteria may be provided by the entity requesting the training of the AI asset. In some embodiments, at least one aspect of the definition and training criteria is inferred or analyzed from the AI asset itself upon uploading.

The known factors may include known factors based on prior trainings of other AI assets by the system.

In certain embodiments, the quotation is based in part on premiums or discounts based on prior quotations of other AI assets by the system.

The preprocessing engine may be further programmed for anonymizing the AI asset (e.g. by homomorphic encryption).

The training may include a training methodology selected from at least one of: example collection, example generation, example curation, training/validation/test sets, loss/error and update model.

The training may further comprise testing the AI asset as to whether a preset level of training has been achieved. In this case, the system may further train the AI asset until the preset level of training has been achieved.

The means of payment may include any means of currency or other exchange of value (including barter or other exchange), either paid (or delivered) contemporaneously or staged or at a certain benchmark. In some cases, the means of payment comprises a payment in a cryptocurrency.

Releasing the AI asset may comprise releasing the AI asset to the entity that uploaded it. The system may be further programmed to provide an identity challenge prior to releasing the AI asset. The identity challenge may, e.g., comprise a two-step authentication process.

According to a second aspect of the invention, a computer-implemented system is provided for automatic training of an artificial intelligence (AI) asset. A preprocessing engine is provided for receiving an AI asset by upload and preprocessing the AI asset for training by: associating a set of definition parameters and training criteria with the AI asset; analyzing the training criteria to set a specification for training steps and process; determining a first quotation for the training having regard to known factors associated with the definition parameters and the training specification up to a first accuracy level; and determining a second quotation for the training having regard to known factors associated with the definition parameters and the training specification up to a second (and different) accuracy level. A transaction engine is provided for presenting the quotations, receiving an approval of one of the first or the second quotation and a means of payment. A training engine is provided for training the AI asset according to the specification and releasing the AI asset after training up to the accuracy level associated with the selected quotation.

### BRIEF DESCRIPTION OF THE FIGURES

FIG. 1 is a flow diagram illustrating a basic process for compiling a quotation for AI asset training for use with an AI asset exchange.

FIG. 2 is a logical diagram illustrating possible configurations of parties (entities) and assets mediated through a related AI asset exchange.

FIG. 3 is a flow diagram illustrating a process for carrying out AI asset training based on an approved quote.

FIG. 4 is a flow diagram illustrating factors provided by an Entity A prior to a quotation process.

FIG. 5 is a flow diagram illustrating a more detailed process for compiling a quotation for AI asset training.

### DETAILED DESCRIPTION

Before embodiments of the invention are explained in detail, it is to be understood that the invention is not limited in its application to the details of the examples set forth in the following descriptions or illustrated drawings. It will be appreciated that numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein.

Furthermore, this description is not to be considered as limiting the scope of the embodiments described herein in any way, but rather as merely describing the implementation of the various embodiments described herein. The invention is capable of other embodiments and of being practiced or carried out for a variety of applications and in various ways. Also, it is to be understood that the phraseology and terminology used herein is for the purpose of description and should not be regarded as limiting.

Before embodiments of the software modules or flow charts are described in detail, it should be noted that the invention is not limited to any particular software language described or implied in the figures and that a variety of alternative software languages may be used for implementation of the invention.

It should also be understood that many components and items are illustrated and described as if they were hardware elements, as is common practice within the art. However, one of ordinary skill in the art, and based on a reading of this detailed description, would understand that, in at least one embodiment, the components comprised in the method and tool are actually implemented in software.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Computer program code for carrying out operations of the present invention may be written in any combination of one or more programming languages, including an object-oriented programming language such as Java, Smalltalk, C++ or the like and conventional procedural programming languages, such as the “C” programming language or similar programming languages. Computer code may also be written in dynamic programming languages that describe a class of high-level programming languages that execute at runtime many common behaviours that other programming languages might perform during compilation. JavaScript, PHP, Perl, Python and Ruby are examples of dynamic languages.

The embodiments of the systems and methods described herein may be implemented in hardware or software, or a combination of both. However, preferably, these embodiments are implemented in computer programs executing on programmable computers each comprising at least one processor, a data storage system (including volatile and non-volatile memory and/or storage elements), and at least one communication interface. A computing device may include a memory for storing a control program and data, and a processor (CPU) for executing the control program and for managing the data, which includes user data resident in the memory and includes buffered content. The computing device may be coupled to a video display such as a television, monitor, or other type of visual display while other devices may have it incorporated in them (iPad, iPhone etc.). An application or an app or other simulation may be stored on a storage media such as a DVD, a CD, flash memory, USB memory or other type of memory media or it may be downloaded from the internet. The storage media can be coupled with the computing device where it is read and program instructions stored on the storage media are executed and a user interface is presented to a user. For example, and without limitation, the programmable computers may be a server, network appliance, set-top box, SmartTV, embedded device, computer expansion module, personal computer, laptop, tablet computer, personal data assistant, game device, e-reader, or mobile device for example a Smartphone. Other devices include appliances having internet or wireless connectivity and onboard automotive devices such as navigational and entertainment systems.

The program code may execute entirely on a standalone computer, a server, a server farm, virtual machines, on the mobile device as a stand-alone software package; partly on the mobile device and partly on a remote computer or remote computing device or entirely on the remote computer or server or computing device. In the latter scenario, the remote computers may be connected to each other or the mobile devices through any type of network, including a local area network (LAN) or a wide area network (WAN), or the connection may be made to the internet through a mobile operator network (e.g. a cellular network); WiFi, Bluetooth etc.

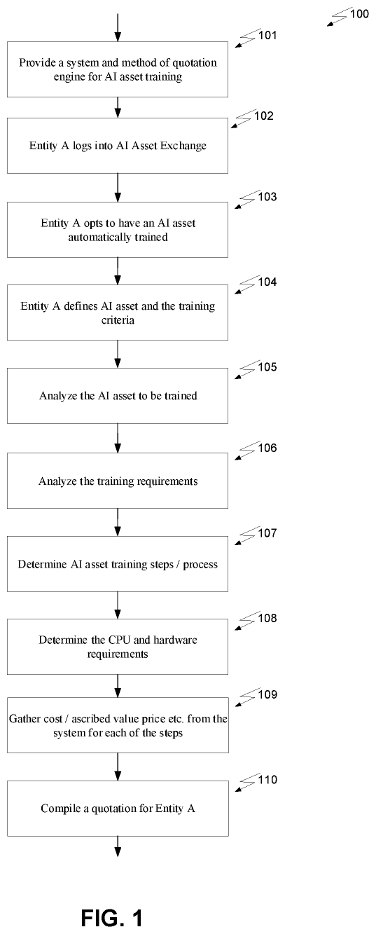

FIG. 1 shows one embodiment in which a system and method is provided of quoting for AI asset training 101. Such a system and method is preferably embedded in or related to an AI Asset Exchange where different entities can buy, sell, barter, trade, rent, borrow, exchange, collaborate, retrain their AI assets etc. that they may have developed or possess rights to.

Entity A logs into an AI Asset Exchange 102. The Exchange aims to provide a platform that acts like a stock exchange where AI assets can be transacted by different parties. The AI Asset Exchange may be responsible for automatically providing a quote in response to a user seeking to have their AI assets trained, grading AI assets, management, transaction management, rights and encryption key(s) management, data management, model management, amongst other related functions.

One related AI Asset Exchange method and system is described and taught in applicants' previous U.S. patent application Ser. No. 16/404,849, filed on May 7, 2019, the contents of which are incorporated herein by reference.

Such an AI Asset Exchange would preferably permit different entities to buy, sell, barter, trade, rent, borrow, exchange, collaborate, retrain their AI assets etc. The AI Asset Exchange may be responsible for grading AI assets, management, transaction management, rights and encryption key(s) management, data management, model management, automated training, providing automated quotes in response to requests for AI asset training amongst other related functions.

One such evaluation and grading tool is described and taught in applicants' previous U.S. patent application Ser. No. 16/507,230, filed on Jul. 10, 2019, the contents of which are incorporated herein by reference.

Artificial Intelligence (AI) aims to be able to provide capabilities such that the computing platforms can perform intelligent human processes like reasoning, learning, problem solving, perception, language understanding etc. AI also aims to use computing to solve problems related to prediction, classification, regression, clustering, and function optimization amongst a host of others.

An AI asset can be data or a model; and any AI asset can be bought, sold, rented, leased; fully (whole) or partially (a subset of the data, say 50%) bartered, exchanged, borrowed, collaborated on etc. An AI asset is tangible (e.g. data or model) and can be transacted, can be assigned value, can be graded by the system and rated by the user, can be extended or muted. The AI Asset Exchange can be responsible for asset management, transaction management, rights (encryption key) management, data management, model management, grading of assets.

The application cites several examples for AI assets, but the intent is to cover all such AI software, modules, models, algorithms etc. that may exist currently or will be developed or may evolve over time as a result of the advancements in the relevant fields of computing.

It would be advantageous to have a mechanism whereby the system could automatically generate a quotation in response to a user requesting an AI asset to be trained using multiple different AI assets potentially belonging to many different entities. Such systems and methods may preferably facilitate trade and transaction of different AI assets by having them trained or retrained and thus increasing their value.

The functionality of the AI Asset Exchange of invention may be embedded in another platform. In another embodiment of the invention the functionality of the AI Asset Exchange of invention may be associated with a stock exchange where stock and commodities are traded using market-based pricing mechanisms like supply and demand.

Entity A preferably first registers with the AI Asset Exchange which may require providing information about the entity and its representatives which are then stored in an account.

An AI asset can be data or a model; and any AI asset can be bought, sold, rented, leased, traded, borrowed, lent, donated, exchanged; fully (whole) or partially (a subset e.g. 50%).

An AI asset is tangible (e.g. data, algorithm, model) and can be transacted, can be assigned value, can be graded by the system and rated by the system and/or users, can be extended or muted.

The AI Asset Exchange may be responsible for asset management, trade and financial transaction management, rights and encryption key(s) management, data management, model management, grading of assets amongst a host of other functions.

Entity A preferably defines its AI asset(s) e.g. if the AI asset is a data set, then what kind of data it is, its size, its bias, and if it's an AI model then what kind of an AI model, its applicability, the industry or vertical that it may be trained on etc. Then, Entity A uploads its AI asset(s) to the AI Asset Exchange.

Entity A opts to have an AI asset automatically trained 103. The present system and methods may preferably facilitate in accelerating the evolution of an AI asset owned by an entity by leveraging the AI resources developed by other entities and available for trade via an AI Asset Exchange.

The process of training an AI asset e.g. a machine learning model involves providing a Machine Learning (ML) algorithm (that is, the learning algorithm) with training data to learn from. The training data must contain the correct answer, which is known as a target or target attribute. The learning algorithm finds patterns in the training data that map the input data attributes to the target (the answer that is required to be predicted), and it outputs an ML model that captures these patterns.

Thereafter the ML model can be used to obtain predictions on new data for which the answers / targets are not known.

Model training and retraining may include but is not limited to Example Collection, Example Generation, Example Curation, Training/Validation/Test Sets, Loss/Error and Update Model etc.

The Training Modes may include but are not limited to Supervised and Unsupervised learning, Reinforcement learning, Online learning i.e. learn as you go amongst others by using online assets.

Entity A defines AI asset and the training criteria 104, which may include but is not limited to accuracy, precision, etc.

The system analyzes the AI asset to be trained 105, preferably using other systems and sub-systems that are either integral to the AI Asset Exchange or in collaboration with other systems that may be external to it and accessible for such purposes.

The system analyzes the training requirements 106, as defined by Entity A who may own or may have rights to the AI assets for which training is being sought.

The system determines AI asset training steps/process 107 that may be required to achieve the desired level of requirements that were earlier set by Entity A as requirements for the training.

The system determines the CPU and hardware requirements 108 that may be utilized during the training process. In some embodiments these may be broad projections and estimates utilizing past historical data to arrive at the specifics. In some embodiments an element of time may also be used to determine the overall length of the training process and the resources that may be required over this length of time. In some embodiments it may also require that a request to book the resources is also automatically generated and a projected schedule is created that may determine when the training is to commence and when it can be expected to be complete.

This may also include an analysis and calculation of the time that may be required, the energy that may be consumed and other resource requirements such as the number of CPUs and their usage load and the expected yields of task completion. These and other criteria may be used for generating an automated quotation in response to an entity seeking training for its AI assets.

The system gathers cost/ascribed value or price etc. from the system for each of the steps 109.

The system compiles a quotation for Entity A 110 in response to the request and requirements set by Entity A for the training of an AI asset. In one embodiment the quotation generation itself may be reliant on artificial intelligence machine learning algorithms that can learn and adapt as the system processes different AI asset training requests from different users.

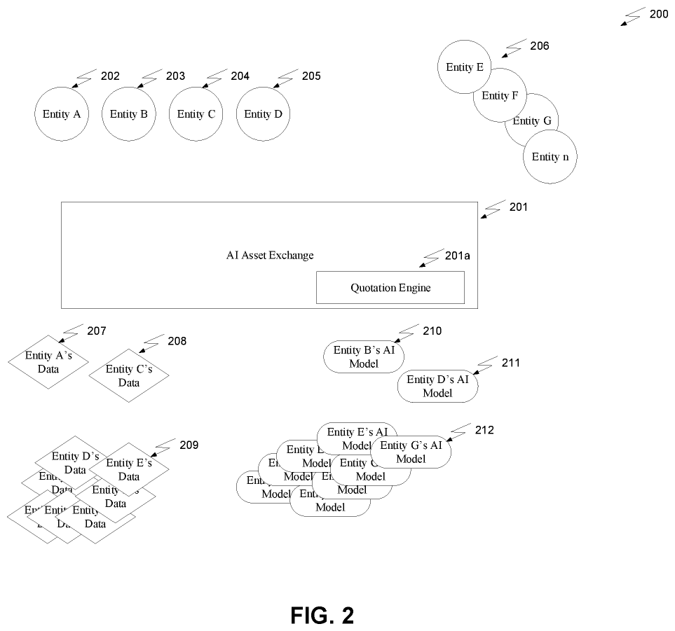

FIG. 2 shows one embodiment of the invention 200 in which a logical view is depicted of the AI Asset Exchange 201 and the Quotation Engine 201a, along with different entities and the AI assets they may own or have rights to transact.

Entity A 202 owns or has rights to Entity A's Data 207. Entity B 203 owns or has rights to Entity B's AI Model 210. Entity C 204 owns or has rights to Entity C's Data 208. Entity D 205 owns or has rights to Entity D's AI Model 211.

Similarly, other entities 206 (Entity E, Entity F, Entity G to Entity n) have rights to transact Data sets 209 and AI Models 212.

AI Models may include but are not limited to Decision Trees, Linear Regression Models, Support Vector Machines, Artificial Neural Networks and the like. Artificial Neural Systems is an approach to AI where the system aims to model the human brain, simple processes are interconnected in a way that they simulate the connection of the nerve cells in the human brain, and the output from the ANS is compared with the expected output and the processors can be retrained.

AI assets may include reasoning related items e.g. non-monotonic reasoning, model-based reasoning, constraint satisfaction, qualitative reasoning, uncertain reasoning, temporal reasoning, heuristic searching etc.

AI assets may include Machine Learning related e.g. evolutionary computation, case-based reasoning, reinforcement learning, neural network, data analysis etc.

AI assets may include Knowledge Management related items e.g. logic, multiagent systems, decision support system, knowledge management, knowledge representation, ontology and semantic web, computer-human interaction etc.

AI assets may include items related to robotics, perception, and natural language processing related; robotics and control, artificial vision including sensing and recognizing images, speech recognition, speech synthesis etc.

Natural Language Processing and Speech Recognition include AI systems that can be controlled and respond to human verbal commands, including classification, machine translation, question answering, text and speech generation, speech including speech-to-text, text-to-speech, speech synthesis etc.

Vision systems may include computing that may be used to sense, recognize and make sense of images, comparisons to Knowledge Base, pattern matching and understanding objects, including systems for image recognition, machine vision and the like.

Machine Learning (ML) may include deep learning, supervised and unsupervised learning, robotics, expert systems, and planning.

Natural Language Understanding (NLU) may include subtopic in Natural Language Processing (NLP) which focus on how to best handle unstructured inputs such as text (spoken or typed) and convert them into a structured form that a machine can understand and act upon. The result of NLU is a probabilistic understanding of one or more intents conveyed, given a phrase or sentence. Based on this understanding, an AI system may then determine an appropriate disposition.

Natural Language Generation on the other hand, is the NLP task of synthesizing text-based content that can be easily understood by humans, given an input set of data points. The goal of NLG systems is to figure out how to best communicate what a system knows. In other words, it is the reverse process of NLU.

Generative Neural Nets or Generative Adversarial Networks (GAN) is an unsupervised learning technique where given samples of data (e.g. images, sentences) an AI system can then generate data that is similar in nature. The generated data should not be discernable as having been artificially synthesized.

The AI assets may be anonymized before being offered for trade. Techniques such as homomorphic encryption may be advantageously used such that the AI assets are made available in an encrypted form for trading.

Homomorphic encryption is a method of performing calculations on encrypted information without decrypting it first. Homomorphic encryption allows computation on encrypted data and may produce results that are also encrypted.

Homomorphic encryption can also be used to securely chain together different services without exposing sensitive data or the AI model to any of the participants in the chain. For example, Entity A's model can be used to produce a result after interacting with Entity B's encrypted data set. In this case homomorphic encryption prevents Entity A from knowing what Entity B's data is and also prevents Entity B from knowing anything about Entity A's AI model.

Thus, homomorphic encryption enables entities to chain together in providing a final solution without exposing the unencrypted data or the AI model to each of those entities participating in the chaining process.

The system and methods of the invention aim to enable the smooth handover of the AI assets being transacted between two or more entities so that the buyers and sellers are anonymized. In one embodiment of the invention the anonymization of the AI Assets may be at the AI asset exchange level. While in another embodiment of the invention this process may be at the level of the buyers and sellers, thus the system and method of invention ensures that all entities are anonymized and none of the participants in a transaction know who the others entities are.

In one embodiment of the invention complete financial transaction as an agreement, or communication, carried out between a buyer and a seller to exchange an AI asset for a payment while the AI Asset Exchange may preferably deduct a fee for enabling the said financial transaction.

A financial transaction involves a change in the status of the finances of two or more entities involved in the transaction. Preferably the buyer and seller are separate entities where a seller is an entity that is seeking to part with certain goods, while a buyer is an entity seeking to acquire the said goods being sold by the seller in exchange for an instrument of conveying a payment e.g. money.

In one embodiment an AI asset is exchanged for an instrument of payment e.g. money; and results in a decrease in the finances of the purchaser and an increase in the finances of the sellers while the AI Asset Exchange may preferably deduct a fee for enabling the said financial transaction.

In one embodiment the financial transaction may be such that the AI asset and money are exchanged at the same time, simultaneously. In another embodiment of the invention a financial transaction may be such that the AI asset is exchanged at one time, and the money at another for example in one case the money is paid in advance, while in another case the money is paid after the AI asset has been utilized e.g. payment is made after having trained an AI model for a period of ten days on a given set of data.

In one embodiment complete financial transaction between the buyer of the AI asset and the seller of the AI asset by decreasing the finances of the purchaser and increasing the finances of the sellers and preferably the AI Asset Exchange deducts a fee from the amount paid by the seller for enabling the said financial transaction.

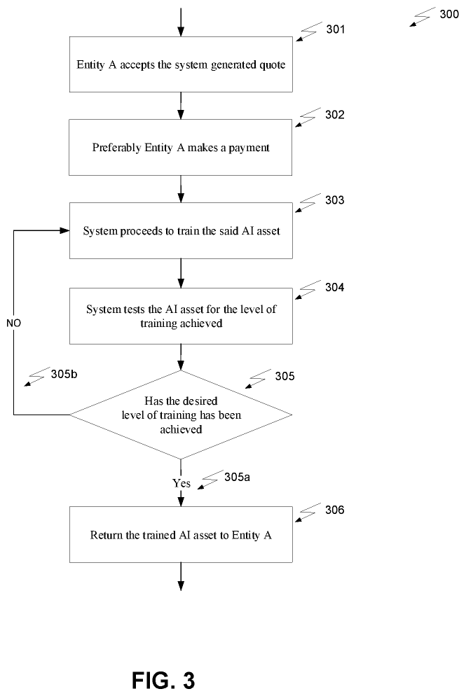

FIG. 3 shows one embodiment of the invention 300, in which Entity A accepts the system generated quote 301.

Entity A preferably makes a payment 302 in order for the system to proceed with the requested training of the AI asset. In other embodiments the payments may preferably be done at any other point in time for example at the end of the training, or in parts over a period of time as the training progresses, etc.

The transaction may be conducted with standard instruments of monetary exchange for example currencies using any of the given payment methods like credit cards, debit cards, cash, PayPal and other such mechanisms.

In other embodiments the transaction may be conducted using cryptocurrencies like Bitcoin. A cryptocurrency is a digital asset designed to work as a medium of exchange that uses strong cryptography to secure financial transactions, control the creation of additional units, and verify the transfer of assets. The validity of each cryptocurrency's coins is provided by a blockchain. A blockchain is a continuously growing list of records, called blocks, which are linked and secured using cryptography. Each block typically contains a hash pointer as a link to a previous block, a timestamp and transaction data. By design, blockchains are inherently resistant to modification of the data.

The system proceeds to train the AI asset 303 as per the training requirements that were earlier set by Entity A.

Model training and retraining may include but is not limited to Example Collection, Example Generation, Example Curation, Training/Validation/Test Sets, Loss/Error and Update Model etc.

The Training Modes may include but are not limited to Supervised and Unsupervised learning, Reinforcement learning, Online learning i.e. learn as you go amongst others by using online assets.

The system preferably evaluates the retrained model. The new evaluation process may use techniques and methods used earlier for the given AI Asset or may use entirely different techniques and methods, as the criteria for the AI Asset may change entirely after the retraining process and may require different techniques and methods and different sequences for them.

System tests the AI asset for desired level of training 304 which may be done by first establishing a baseline when starting the training process and as training is conducted performing evaluations and tests to check its progress compared to the baseline.

The system checks whether the desired level of training has been achieved 305. This may be checked against the established criteria as defined by Entity A when the request for training was initiated or another benchmark or industry baseline.

The system checks whether the AI asset has reached the desired level of training—if Yes 305a, then the system proceeds to the next step 306. If No, the AI asset has not reached the desired level of training 305b, then the system continues with the training process 303 and continues to test and re-evaluate the asset.

The system returns the trained AI asset to Entity A 306 e.g. by enabling its authorized download after Entity A has satisfactorily provided the requisite response to the identity challenge e.g. using a two-step authentication process.

The present system and methods aim to enable the rights management of AI assets to control and enforce the AI Asset transactions. For example, if a dataset or a model was rented or leased for a duration of 5 days, then automatically expiring the encryption keys after that duration to enforce the agreement. This enables transactions like renting data for a duration, buying a portion of a data set, buying a given number of hops of data training from different entities for model training, each hop may have a notion of limited time (renting for a duration) and data size (train on a part of data set or whole data set) associated with it.

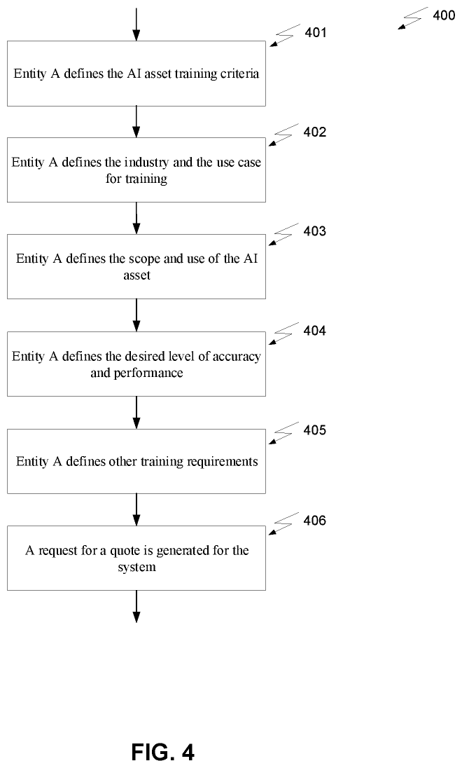

FIG. 4 shows one embodiment of the invention 400, in which Entity A defines the AI asset training criteria 401 that may be composed of different sub-sets of requirements for training.

Entity A defines the industry and the use case for training criteria 402.

Entity A defines the scope and use of the AI asset 403.

Entity A defines the desired level of accuracy and performance 404.

Entity A defines other training requirements 405.

A request for a quote is generated for the system 406. This may be a request to generate a quote that is machine understandable.

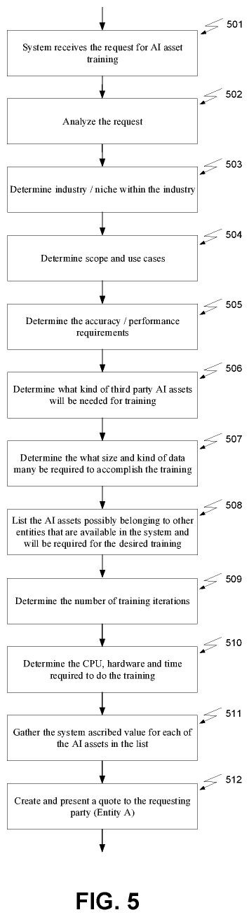

FIG. 5 shows one embodiment of the invention, in which the system receives the request for AI asset training 501, for example a request to train an AI model to identify cancerous brain tumors in MRI (Magnetic Resonance Imaging) scans with a size of 10mm or more. MRI is a non-invasive diagnostic imaging test that takes detailed images of the soft tissues of the body. Currently physicians study the scans and based on experience find cancerous or other malignant areas in a patient's body. MRI scans are also used by physicians to plan cancer treatment, like surgery or radiation. The request for training may be originated from a user accessible interface e.g. a website or a voice activated channel that can take verbal commands from a user and create a machine understandable request.

The system analyzes the request 502. The analysis of the request for AI asset training may involve running sub-tasks to better comprehend the scope of the AI asset training.

The system determines the industry/niche within the industry 503. For our example the system determines that the industry is medical, the niche is MRI imagining. Since medical data is not easily available, system adds a premium of $1000.

The system determines the scope and use cases 504 for which the training is required, which are preferably the same as those provided by the entity requesting training. For our example the system determines that the scope and use cases are related to detection of cancerous tumors in the brain. The scope and use cases may be determined by analyzing the historical data in the system and establishing patterns from it. For our example the system determines that since images of MRI scans are even more difficult to obtain, another premium of $1000 is added.

The system determines the accuracy/performance requirements 505 e.g. desired accuracy, precision, etc. for the desired training of the AI asset, and preferably these parameters are provided by the entity requesting training. For our example the system determines that since the minimum tumor size is 10mm in order to achieve the desired accuracy it adds $2000.

Where the entity requesting the AI training may not have provided exact parameters for accuracy/performance requirements, the system may generate a few different tiers and create multiple quotations, one each for the different tiers. Thus the entity requesting the AI training may then opt for a level of accuracy/performance that may suit their budget.

The system determines what kind of third-party AI assets will be needed for training 506 given the industry, niche in the industry, scope and use cases, accuracy and performance. In one embodiment the determination for the third-party assets that will be needed for training the target AI asset may utilize artificial intelligence machine learning algorithms. For our example the system determines that for the training of the AI model. MRI brain scans of patients where cancerous tumors have been accurately detected by neuro-oncologists as well as MRI scans of healthy brains with no cancerous tumors detected or only benign tumors detected are required. For our example the system determines that since the training data requires images of MRI brain scans where cancerous tumors of at least 10mm have been successfully detected by a neurologist it adds $3000.

The system determines the size and kind of data that may be required to accomplish the training 507. In one embodiment the determination for the size and kind of data that may be required to accomplish the training of the target AI asset may utilize artificial intelligence machine learning algorithms e.g. the system can search the web and discover/determine that in the U.S., brain or nervous system tumors affect approximately 6 of every 1,000 people. For our example the system determines that since brain tumors are rather rare in human brains (6 out of 1000) and to achieve desired accuracy (10 mm) hundreds of MRI images of brain scans may be required for training, the system adds $1500.

The system lists the AI assets possibly belonging to other entities that are available in the system and will be required for the desired training 508. In one embodiment of the invention list the AI assets possibly belonging to other entities that are available in the system and will be required for the desired training of the said AI asset. For our example the system may perform a search of the data stored in the system or its allied resources e.g. cloud storage to determine if there is diagnostic medical data from hospitals or imaging labs related to MRI scans and more pointedly if the system has MRI brain scans available. For our example the system detects that it has images of MRI brain scans with benign tumors from a hospital available in its allied resources but the data will need to be anonymized, so it adds $1000 for that.

Since the internally available data is limited to benign brain tumors, the system may preferably also opt to search and find publicly available data related to MRI brain scans with cancerous tumors e.g. from a teaching hospital that makes such data available for research to qualified institutions or physician training. For our example the system determines that such data is available from a teaching hospital for a subscription fee of $500 per month.

The system determines the number of training iterations 509 to achieve the desired level of training for the said AI asset. For our example, since it involves healthcare the system determines that at least 5 iterations of training may be required with 100 images of MRI brain scans with cancerous tumors, 50 images of MRI brain scans with benign tumors and 20 images of healthy MRI brain scans with no tumors, in each iteration. With a fee of $500 per iteration, a total of $2500 is added.

The system determines the CPU, hardware and time required to do the training 510 to achieve the desired level of training for the said AI asset. For our example, since the desired accuracy of the cancerous brain tumor is 10 mm, the system determines that 10 CPUs, and 3 months of training time may be required to train the AI model. With a fee of $400 per month for computing resources, therefore for our example the system adds $1200. The system also adds $1500 for a 3-month subscription fee for the teaching hospital to acquire the MRI scans.

Preferably the system may also add a fee of $500 per person per day for 2 human resources for 3 days to review and test the model before and after the training, thus a total of $3000. Preferably the requesting party may also have the option to increase or decrease the number of human resources as well as the time for review and testing of the AI model.

The system gathers the ascribed values for each of the AI assets in the list 511.

| | |
|---|---|
| Premium for medical data - | $1000 |
| Premium for MRI scans - | $1000 |
| Accuracy and performance - | $2000 |
| Third party MRI brain scans - cancerous tumors 10 mm | $3000 |
| detected - | |
| Size and kind of data - | $1500 |
| Internal images of MRI brain scans requiring anonymization - | $1000 |
| Teaching hospital subscription fee $500 per month - 3 months | $1500 |
| subscription - | |
| Iteration fee $500 per cycle - 5 iterations - | $2500 |
| Computing resources for 3 months - | $1200 |
| Human review and testing - | $3000 |
| GRAND TOTAL - | $17,700 |

As shown in the example above, the system creates and presents a quote to the requesting party (Entity A) 512 for the AI asset training. The quotation generation itself may be reliant on artificial intelligence machine learning algorithms that can learn and adapt as the system processes different AI asset training requests from different users.

The artificial intelligence machine learning algorithms may preferably use historical data to fine tune the quotation. For example, the system may analyze previous historical quotes generated for other medical imaging related requests.

The machine learning algorithms may preferably generate multiple quotations each using a varying set of criteria that may train the AI asset. Preferably one or more quotations may be sent to the entity requesting the AI asset training.

For our example the system may preferably generate a second quote with a training time of 1 month that reduces the computing resources required as well as the subscription fee for the imaging data acquired from the teaching hospital.

The artificial intelligence machine learning algorithms may preferably use historical data to fine tune the quotation.

The machine learning algorithms may preferably generate multiple quotations each using a varying set of criteria that may train the AI asset. Preferably one or more quotations may be sent to the entity requesting the AI asset training.

The program code may execute entirely on a computing device like a server, a cluster of servers, computing devices that are physical or virtual, or a server farm; partly on a physical server and partly on a virtual server; or partially or totally make use of cloud computing. The different computing devices may be connected to each other through any type of network, including a local area network (LAN) or a wide area network (WAN), or the connection may be made to the internet through a mobile operator network (e.g. a cellular network).

Several exemplary embodiments/implementations of the invention have been included in this disclosure. There may be other methods obvious to persons skilled in the art, and the intent is to cover all such scenarios. The application is not limited to the cited examples, but the intent is to cover all such areas that may be benefit from this invention. The above examples are not intended to be limiting but are illustrative and exemplary.

What is claimed is:

1. A computer-implemented system for automatic training of an artificial intelligence (AI) asset, comprising:
a preprocessing engine for receiving an AI asset by upload and preprocessing the AI asset for training by:
associating a set of definition parameters and training criteria with the AI asset;
analyzing the training criteria to set a specification for training steps and process;
determining a quotation for the training having regard to known factors associated with the definition parameters and the training specification;
a transaction engine for presenting the quotation, receiving an approval of the quotation and a means of payment; and
a training engine for training the AI asset according to the specification and releasing the AI asset after training.

2. The system of claim 1, wherein the factors include at least one of: industry, use case, scope and use of the AI asset, desired level of accuracy, and desired level of performance.

3. The system of claim 1, wherein the factors include at least one of: type of third party AI assets needed for training, type and scope of data needed for training, and access cost and availability of training data sets.

4. The system of claim 1, wherein the factors include at least one of: estimated number of training iterations, and CPU, hardware and time to do training.

5. The system of claim 1, wherein the definition and training criteria are provided by the entity requesting the AI asset training.

6. The system of claim 1, wherein at least one aspect of the definition and training criteria is inferred or analyzed from the AI asset itself upon uploading.

7. The system of claim 1, wherein the known factors include known factors based on prior trainings of other AI assets by the system.

8. The system of claim 1, wherein the quotation is based in part on premiums or discounts based on prior quotations of other AI assets by the system.

9. The system of claim 1, wherein the preprocessing engine is further programmed for anonymizing the AI asset.

10. The system of claim 1, wherein the training includes a training methodology selected from at least one of: example collection, example generation, example curation, training/validation/test sets, loss/error and update model.

11. The system of claim 1, wherein the training further comprises testing the AI asset as to whether a preset level of training has been achieved.

12. The system of claim 11, further comprising further training the AI asset until the preset level of training has been achieved.

13. The system of claim 1, wherein the means of payment comprises a payment in a cryptocurrency.

14. The system of claim 1, wherein releasing the AI asset comprises releasing the AI asset to the entity that uploaded it.

15. The system of claim 14, further comprising an identity challenge.

16. The system of claim 15, wherein the identity challenge comprises a two-step authentication process.

17. A computer-implemented system for automatic training of an artificial intelligence (AI) asset, comprising:
a preprocessing engine for receiving an AI asset by upload and preprocessing the AI asset for training by:
associating a set of definition parameters and training criteria with the AI asset;
analyzing the training criteria to set a specification for training steps and process;
determining a first quotation for the training having regard to known factors associated with the definition parameters and the training specification up to a first accuracy level;
determining a second quotation for the training having regard to known factors associated with the definition parameters and the training specification up to a second (and different) accuracy level;
a transaction engine for presenting the quotations, receiving an approval of one of the first or the second quotation and a means of payment; and
a training engine for training the AI asset according to the specification and releasing the AI asset after training up to the accuracy level associated with the selected quotation.
